(19) United States
(12) Patent Application Publication
(10) Pub. No.: US 2007/0113656 A1
(43) Pub. Date: May 24, 2007

(54) ACOUSTIC IMAGING SYSTEM

(76) Inventor: Terry Murray, Winchester, MA (US)

Correspondence Address: McGUINNESS & MANARAS LLP, 125 NAGOG PARK, ACTON, MA, 01720, US

(21) Appl. No.: 11/562,512

(22) Filed: Nov. 22, 2006

Related U.S. Application Data
(60) Provisional application No. 60/739,747, filed on Nov. 23, 2005.

(51) Int. Cl. G01H 9/00

(52) U.S. Cl. 73/655

(57) ABSTRACT

A system for providing an acoustic image that visually represents sound includes a light source, a liquid membrane, a sound source and a display device. Light from the light source is directed at one face of the liquid membrane as the sound source generates sound waves that are directed to the liquid membrane. The liquid membrane vibrates at resonant frequencies, changing the surface area of the liquid membrane. Light is reflected off of the liquid membrane as interference color, and captured as an image which provides a high fidelity translation of the audio signals that varies in pattern and color based on the audio signal.

### RELATED APPLICATIONS

This application claims priority under 35 U.S.C. §19(e) to provisional patent application Ser. No. 60/739747, filed Nov. 23, 2005 by Terry Murray and incorporated herein by reference.

### FIELD OF THE INVENTION

The present invention is directed to an acoustic imaging system that provides high fidelity display of sound using liquid optics.

### BACKGROUND OF THE INVENTION

Research has shown that most people learn through a combination of visual and auditory input. However, some people show learning preferences for one or the other; auditory learners do respond well to visual learning materials, while visual learners tend to suffer in auditory based teaching situations, such as lectures. Educator's recognition of the different learning styles has caused them to search for multi-sensory presentation techniques that may be used to provide information in the classroom.

One example of a multi-sensory presentation system is a system that visually represents sound. One such system is described in Pat. No. 3,590,681 by Cross, incorporated herein by reference. In this system, light and sound waves were directed towards a plastic or rubber diaphragm, and the vibrations caused by sound on the diaphragm were reflected, using a mirror, onto a screen. Although this system is effective, the tensile characteristics of the diaphragm provided low fidelity translation. It would be desirable to identify a system that would provide a high fidelity visual display of sound.

### SUMMARY OF THE INVENTION

According to one aspect of the invention, an acoustic imaging system includes a light source, a liquid membrane, a sound source and a display device. Light from the light source is directed at one face of the liquid membrane as the sound source generates sound waves that are directed to the liquid membrane. The liquid membrane vibrates at resonant frequencies; an image generated from light that is reflected off the vibrating membrane provides a high fidelity translation of the audio signals.

### BRIEF DESCRIPTION OF THE FIGURES

FIG. 1 is a perspective view of an acoustic imaging system of the present invention;

FIGS. 2A-2C illustrate various views of a mechanism for obtaining a liquid membrane for use in the present invention;

FIG. 3A is a diagram illustrating the operation of the system of the present invention to display the light provided from the liquid membrane of the present invention;

FIG. 3B is a diagram illustrating the operation of the system of the present invention when the noise is applied to the liquid membrane of the present invention, and illustrates how the noise may be visualized using the liquid membrane;

FIG. 4 illustrates a system that uses the present invention to display visualized sound on a display device;

FIG. 5 illustrates an alternate embodiment of the present invention which includes an additional reflective surface for reflecting the visual representation of the sound onto a display screen.

### DETAILED DESCRIPTION

The present invention is directed at an acoustic imaging system for broadcasting the fluid dynamics of a liquid membrane onto a visible screen to allow the effects of the application of sound to the membrane to be observed for educational, artistic, musical, entertainment or other purposes.

In physics, resonance is the tendency of a system to absorb more oscillatory energy when the frequency of the oscillations matches the system's natural frequency of vibration (its resonant frequency) than it does at other frequencies.

In sound applications, a resonant frequency is a natural frequency of vibration determined by the physical parameters of the vibrating object. This same basic idea of physically determined natural frequencies applies throughout physics in mechanics, electricity and magnetism, and even throughout the realm of modem physics. Some of the implications of resonant frequencies are that it is easy to get an object to vibrate at its resonant frequencies, and harder to get it to vibrate at other frequencies. A vibrating object will pick out its resonant frequencies from a complex excitation and vibrate at those frequencies, essentially “filtering out” other frequencies present in the excitation. Most vibrating objects have multiple resonant frequencies.

The present invention is an acoustic imaging system which facilitates the visualization of sound. One known method of visualizing sound is to direct sound at a membrane while reflecting light off of the membrane onto a surface. In response to the sound, sound nodes appear in the membrane, with the sound nodes resulting from vibration of the membrane at the resonant frequencies of the membrane. Reflected light from the membrane provides an observable visual pattern of the sound nodes, enabling a user of the system to experience the sound in a multi-sensory manner.

According to one aspect of the invention, it is realized that a visual display capable of displaying an audio signal with high fidelity may be obtained by using a reflective membrane with a high number of resonant frequencies. It is also recognized that the resonant frequencies of a material are related to the surface tension of the material, and that liquids have less surface tension than solids. A preferred embodiment of the present invention thus uses a liquid membrane to visually display audio signals because the increased number of resonant frequencies of the membrane may be used to provide high fidelity audio display.

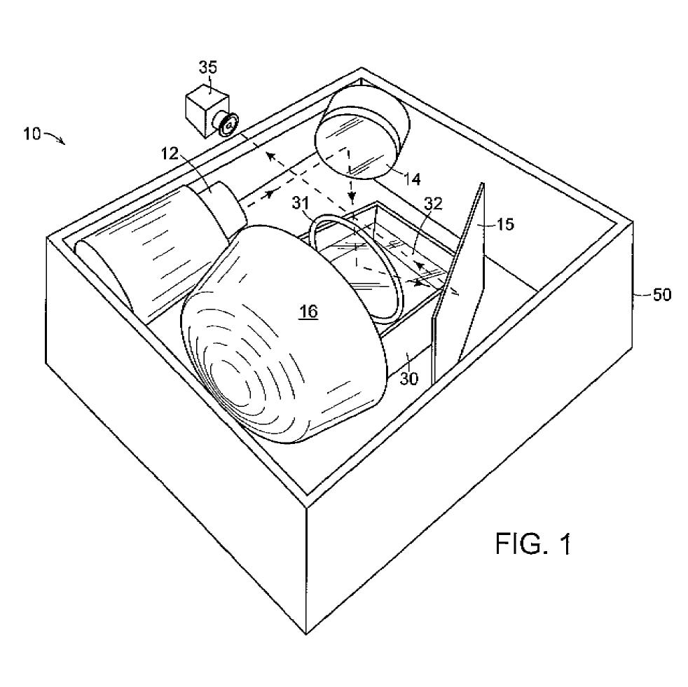

FIG. 1 is a diagram of an acoustic imaging system 10 of the present invention. The system includes a light source 12 lights a reflective surface such as mirror 14. The mirror essentially ‘orders’ the light from source 12, translating the diffuse light from the source 12 into a light column directed onto a liquid membrane 20 which is supported by a ring 31. A large percentage of the light flows through the liquid membrane, but a portion of the light is reflected off of the surface of the membrane onto screen 15 as interference colors. A speaker 16, positioned near the liquid membrane, is used to provide a source of sound. The sound causes the liquid membrane to vibrate at the resonant frequencies of the sound. Because the liquid membrane is able to resonate at multiple resonant frequencies, the sound nodes associate with the sound can be easily viewed on the membrane.

One feature of the present invention is that the vibration of the liquid membrane varies the thickness of the membrane. The variations in thickness of the membrane result in variations in interference color the reflected display. Interference color results from waves of light interacting with each other to produce constructive reinforcement or destructive cancellation of the waves. As the sounds near the liquid membrane stimulate resonate frequencies of the liquid, the liquid develops sound nodes and ante nodes of with different peak heights and valley depths, causing a pleasing color pattern to be displayed in the visual image of the sound. A camera 35 may be directed at the screen for capturing the image displayed on screen 15 for display to a user.

Thus a liquid membrane provides an improved acoustic imaging system because it has a low surface tension and associated high number of resonant frequencies, thereby enabling it to show sound as a pattern with increased detail. In addition the malleable nature of the liquid membrane cause the membrane to transform in shape and depth when it is exposed to sound, thereby further increasing the color detail with which sound may be viewed.

The issues of evaporation and gravitational pull must be addressed when designing a liquid membrane for use with the present invention. In one embodiment of the invention, the liquid membrane is comprised of a combination of detergent and glycerin. Detergent is selected for its property as an anionic surfactant and glycerin is selected due to its low evaporation rate; glycerin virtually absorbs water from the air. In a preferred embodiment the detergent, which may be, for example, a Joy® dishwashing liquid or other detergent is combined in a ratio of three to one with glycerin, and advantageously cured for a three day period. During this time, excess water from the detergent is absorbed as the soap solution is cured. The resulting liquid may provide a membrane with a decreased evaporation rate.

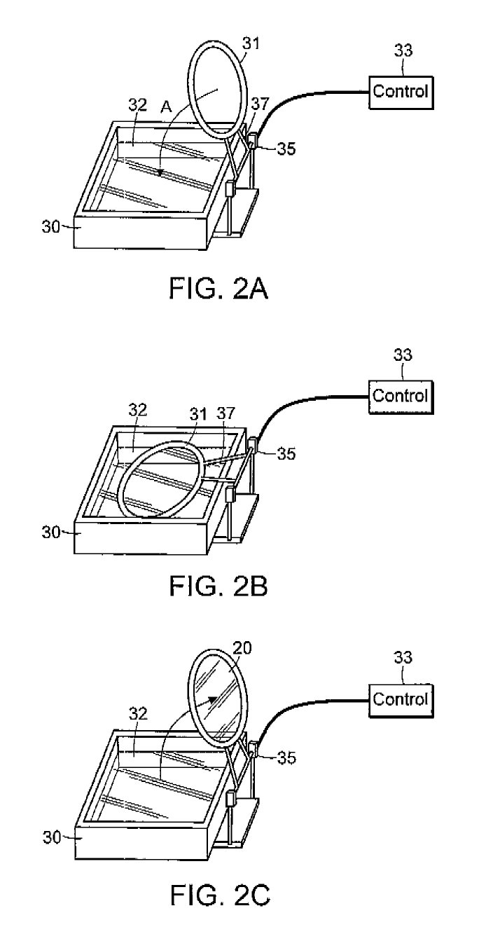

Referring now to FIGS. 2A-2C, according to one aspect of the invention, a ring 31 is positioned on a mechanical arm 37. Actuation of a motor 35 by control 33 causes the mechanical arm to dip downward as indicated by arrow A in FIG. 2A, so that a face of the ring is submerged in a container 30 holding the liquid soap solution 32, as shown in FIG. 1B. The ring remains momentarily in the solution, and then raises out of the solution as indicated by arrow B in FIG. 2B. A portion of the liquid from container 30 forms a liquid membrane 20 which extends across the entire circumference of the ring. Over time, the gravitational pull of on the liquid membrane will cause the liquid to pull away from the ring, eventually destroying the membrane. However, the soap solution is designed such that the glycerin in the liquid membrane essentially sandwiches the soap layer of the membrane, impeding evaporation and increasing the longevity of the membrane. In addition, the mechanical arm can quickly and easily be activated, restoring the membrane within seconds.

According to another aspect of the invention, the method used to generate the liquid membrane is selected to minimize the disturbance to the surface of the liquid in the container 30, in order to minimize the generation of bubbles when the ring dips into the solution. Thus a novel method of generating a liquid membrane optimized for longevity has been shown and described. Although a preferred method of generating a liquid membrane has been shown and described, it should be understood that the present invention is not limited to the user of any particular liquid for forming the membrane, and it is anticipated that other liquid solutions that exist today or are subsequently developed may be substituted herein within the scope of the invention.

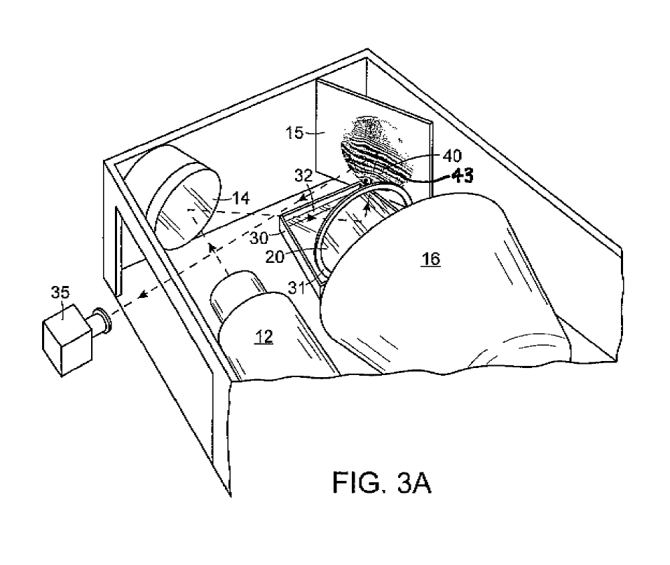

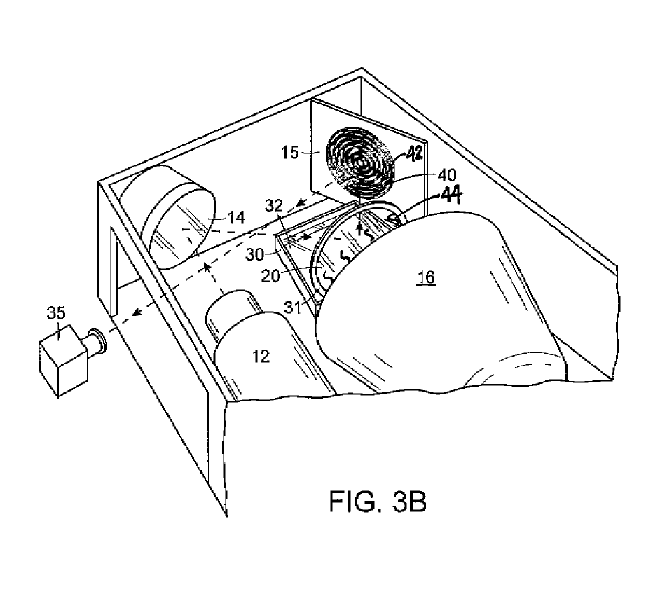

Referring now to FIG. 3A, another perspective view of the acoustic imaging system of the present invention is provided. Light source 12, a sound source 16, a liquid membrane 20, a mirror 14 and a display surface 15 are shown. The light source in the embodiment of FIG. 3A may be any light source, which emits light rays that are directed towards mirror 14. The mirror provides order to the light, and an ordered beam of light is forwarded from a mirror to a first face of the liquid membrane 20. The sound source 16, for example a speaker, is directed at a second face of the liquid membrane, opposite the first face. Sound waves cause vibration of the liquid membrane, causing node and ante-node formation on the surface of the liquid in accordance with the Bessel function. Light waves are reflected off of the surface of the membrane onto the display surface 15 to provide a resulting image 40. As shown in FIG. 3A, the interference colors (shown as layers, wherein each layer 43 is a different interference color) of the image will vary depending upon the depth of the portion of the membrane represented by the image. When the membrane is undisturbed, a gravitational pull will tend to cause the liquid to be thickest towards the bottom of the image, and thinner at the top; a characteristic which is manifested in the different layers of interference colors of the image. A disturbance of the membrane which causes the liquid to flow within ring 31, at different depths, may provide an artistic and visually pleasing multi-color swirled image.

FIG. 3B illustrates the interference colors and sound pattern 42 of a resulting image when sound (represented by sound waves 44) is applied to the liquid membrane. For example, the image now includes a sound representation manifested as a pattern 42 including visual artifacts such as sound node 42. The changes in surface area form that results from the application of sound to the membrane are further manifested by changes in the color pattern of the image. Although not shown in FIG. 3B, the interference colors of the image will also vary in accordance with the resonant frequency and associated thickness of the liquid membrane when resonating at the different frequencies. Thus the liquid membrane allows acoustics to be visualized by altering multiple facets of the image (i.e., color and pattern).

It should be noted that although the embodiment of FIGS. 1, 3A and 3B illustrate the use of a mirror, an image may also be provided by direct application of the light source to the image. Accordingly, embodiments of an acoustic imaging system which include only a light source, liquid membrane and sound source are well within the scope of the present invention.

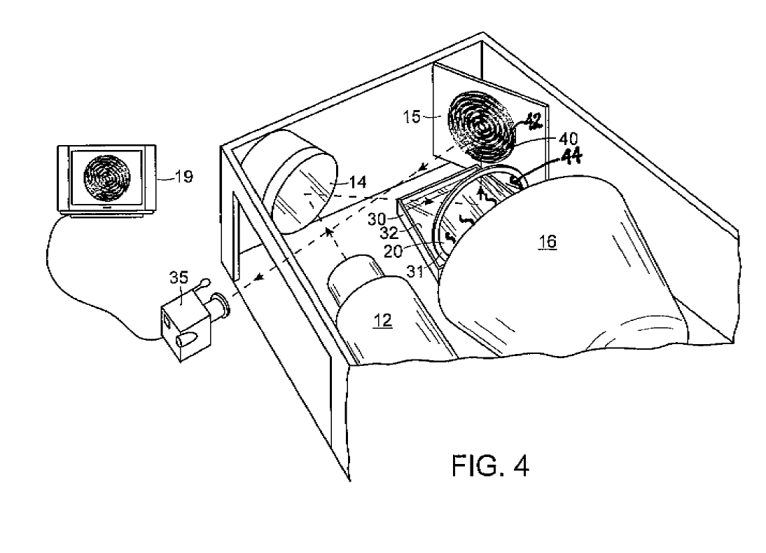

FIG. 4 illustrates how the acoustic imaging system may be used for educational or entertainment purposes by displaying the image 40 on another display medium. In FIG. 4, a camera 35 is directed at image 40 on screen 15. The camera captures the colors that are presented in the image, translates them according to the color palate of the camera, and displays the image on a display such as a TV screen or the like. Alternatively, the camera may be coupled to a projector, which projects the image on a screen. The arrangement of FIG. 4 allows the acoustic images to be displayed to a wide audience.

One limitation of the system of FIG. 4 is that the colors provided in the image on the display 19 will be limited to the color palette provided by the camera and display device 19. Such display devices are not often capable of representing a full interference color spectrum.

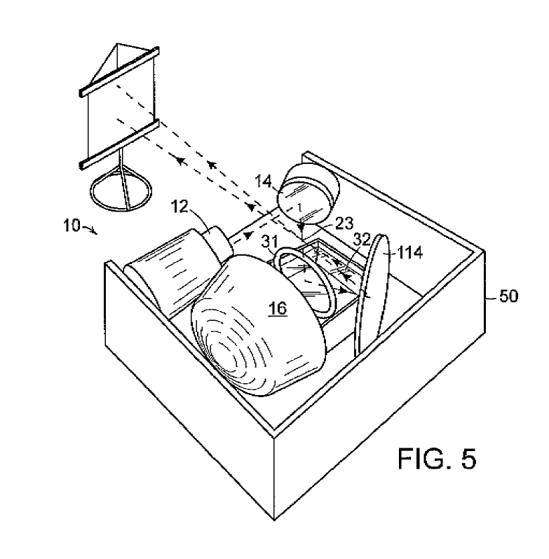

Accordingly, another embodiment of the invention which allows the full interference color spectrum of an acoustic image to be visualized is shown in FIG. 5. In addition to the components shown in the systems of the previous figures, a reverse parabolic reflector 114 is disposed to capture the reflection of the liquid membrane. Light from the parabolic reflector 22 is reflected to the focus point 23, and from there is distributed onto the screen 25. In one embodiment, an object, such as a disk, may be placed at the focus point to filter out light from the light source 22 so that the only the impact of sound vibrations on the interference colors is seen.

Accordingly a method and apparatus for use in displaying sound waves using a liquid membrane provides a high fidelity representation of the audio signal. Several systems that may be used to display the visual image provided by the liquid membrane have been shown and described. While the present invention has been described with regard to the use of a sound source for altering the surface area of a liquid membrane to produce a representative interference color image, it will be appreciated that the present invention is not limited to the use of sound waves. Rather, it is envisioned that other embodiments of the invention which use devices for altering the surface structure of a liquid membrane to responsively vary the depths of the membrane are within the scope of the invention. For example, in ring 31 may be oscillated by a controlled motor, creating a wave for the membrane and resulting in a changing pattern of interference light in response to the wave.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A system for providing a visual image of sound includes:
a liquid membrane;
a light source for providing light to the liquid membrane;
a sound source for altering a surface structure of the liquid membrane; and
a viewing surface disposed near the liquid membrane for displaying light reflected off the membrane as an image.

2. The system of claim 1, wherein the liquid membrane vibrates in response to sound from the sound source, and wherein the image is an acoustic image that represents the sound provided by the sound source.

3. The system of claim 2 wherein the acoustic image varies in at least one of pattern and color in response to the sound source.

4. The system of claim 1 wherein the liquid membrane is comprised of a solution including at least one of glycerin and detergent.

5. The system of claim 4 wherein the liquid membrane is supported by a ring, and wherein the liquid membrane is generated by contacting a radius of the ring with the solution.

6. The system of claim 1 further comprising a camera, disposed to capture the image.

7. The system of claim 6 further comprising a display device, coupled to the camera, for displaying the image captured by the camera.

8. The system of claim 1 further comprising a first mirror for capturing light from the light source and directing the light at the liquid membrane.

9. The system of claim 8 further comprising a second mirror for capturing light reflected off the membrane and directing the light onto the viewing surface.

10. The system of claim 9 wherein the second mirror is a parabolic reflector which directs light to a focus point, and wherein the viewing focus point is between the second mirror and the viewing surface.

11. A system for displaying interference colors comprises:
a liquid membrane;
a light source for providing light to the liquid membrane; and
a display surface, positioned near the liquid membrane to capture interference light that reflects off the liquid membrane as an image comprising interference colors.

12. The system of claim 11, further comprising means for changing the surface structure of the liquid membrane, and wherein interference colors of the image change in response the changing surface structure.

13. The system of claim 11, wherein the means for changing the surface structure of the liquid membrane comprises a sound source positioned near the liquid membrane.

14. A method for providing an acoustic image includes the step of:
generating a liquid membrane;
shining light on the liquid membrane;
capturing an image comprised of interference colors corresponding to light reflecting off the liquid membrane; and
applying sound to the liquid membrane to cause the liquid membrane to resonate at frequencies associated with the sound, wherein the interference colors of the image provide an acoustic image of the sound.

15. The method of claim 15 wherein the image varies in at least one of pattern and color in response to the sound.

16. The method of claim 14 including the step of displaying the image on a display device.

17. The method of claim 16 wherein the step of displaying the image includes the step of recording the image with a camera and displaying the recorded image on the display device.

18. The method according to claim 14 wherein the step of capturing the image includes the step of reflecting the light that reflects off of the liquid membrane onto a parabolic reflector and directing the parabolic reflector at a screen.
